(19) United States
(12) Patent Application Publication
(10) Pub. No.: US 2018/0231186 A1
(43) Pub. Date: Aug. 16, 2018

(54) VALVE BLOCK FOR GAS CYLINDER WITH IMPROVED USAGE SAFETY

(71) Applicant: Air Liquide Medical Systems, Antony (FR)

(72) Inventors: Damien GERMANI, Paris (FR); Christophe REZEL, Savigny sur Orge (FR)

(21) Appl. No.: 15/509,261

(22) PCT Filed: Aug. 27, 2015
(86) PCT No.: PCT/FR2015/052279

§ 371 Date: Mar. 7, 2017

(30) Foreign Application Priority Data
Sep. 9, 2014 (FR) 1458444

(51) Int. Cl. F17C 13/04

(52) U.S. Cl. CPC F17C 13/04; F17C 2250/072; F17C 2201/032; F17C 2201/058; F17C 2203/0617; F17C 2203/0639; F17C 2203/0646; F17C 2203/0648; F17C 2205/0326; F17C 2205/0329; F17C 2205/0338; F17C 2205/0385; F17C 2205/0394; F17C 2221/011; F17C 2221/014; F17C 2221/017; F17C 2221/03; F17C 2221/031; F17C 2223/0123; F17C 2223/036; F17C 2250/043; F17C 2250/0443; F17C 2250/0469; F17C 2250/0482; F17C 2250/0491; F17C 2250/0636; F17C 2201/0114

(57) ABSTRACT

The invention relates to a valve block (1) for a pressurised gas cylinder (20) comprising: an inner gas passage (2) providing fluid connection between a gas inlet opening (10) and a gas outlet opening (11); a gas monitoring system (3) arranged on the inner gas passage (2), making it possible to monitor and/or adjust the flow of gas circulating in said inner gas passage (2); a system for selecting and/or adjusting the flow of gas, comprising a movable operating member (4) which can be actuated by the user and engages with the gas monitoring system (3) in order to monitor and/or adjust the flow of gas exiting via the gas outlet opening (11); an electronic control system (7, 7′, 8) making it possible to control an actuator device (5); an actuator device (5) capable of controlling the movement of a mobile mechanical member (6) in response to a control signal output by the electronic control system (7, 7′, 8); and a mobile mechanical member (6) acting on the operating member (4) of the system for selecting and/or adjusting the flow of gas, in response to an actuation by the actuator device (5), such as to block or release the mobile operating member (4). The invention also relates to a gas distribution assembly comprising a gas cylinder (20) provided with a valve block (1) according to the invention, protected by a protective cover arranged around at least one portion of said valve block (1).

### CROSS REFERENCE TO RELATED APPLICATIONS

This application is a 371 of International PCT Application PCT/FR2015/052279 filed Aug. 27, 2015 which claims priority to French Patent Application No. 1458444 filed Sep. 9, 2014, the entire contents of which are incorporated herein by reference.

### BACKGROUND

The invention relates to a valve block, with or without an integrated pressure relief system, for a pressurized gas cylinder, like a gas bottle, provided with an electronic command system for driving an actuating device commanding the movements of a movable mechanical member such as to block or release the operating member, like a rotating wheel or a pivoting lever, of the system for selecting and/or adjusting the gas flow rate.

The gases and mixtures of gas for medical use which are normally packaged in gas cylinders, like gas bottles, can have several constraints or properties complicating the use thereof.

For example, it is possible to mention a shelf life beyond which a gas or gas mixture must no longer be used, or external conditions making a gas or gas mixture unsuitable for a medical use, for example the phenomenon of “unmixing” at negative ambient temperature (i.e. <0° C.) of the O₂/N₂O mixtures.

Means exist for preventing an inappropriate use of such a gas or gas mixture, such as affixing a label to the packaging or cylinders showing the expiry date of the gas, or using one or more visual and/or sound indicators showing an exposure of the gas cylinder to predefined external conditions, for example negative temperatures.

However, these means are limited to providing information to the user and the effectiveness thereof is therefore subject to the attention of the user. In other words, a user who would not pay attention to the expiry date of a gas or to a visual or sound indicator takes the risk of administering a gas or gas mixture that is unsuitable for a patient, with all of the risks and consequences that result therefrom.

In view of this, the problem at hand is preventing usage of a gas or gas mixture, the administration of which could involve a risk for the patient, said gas or gas mixture being delivered by a valve block with which a gas cylinder, like a gas bottle, is provided.

### SUMMARY

The solution of the invention is a valve block for a pressurized gas cylinder, like a gas bottle, comprising:
a gas internal passage providing fluid connection between a gas inlet opening and a gas outlet opening,
a gas control system arranged on the gas internal passage, for controlling and/or adjusting the flow rate of gas flowing in said gas internal passage,
a system for selecting and/or adjusting the flow rate of gas comprising a movable operating member which can be actuated by the user and engages the gas control system in order to control and/or adjust the flow rate of gas exiting via the gas outlet opening;
an electronic command system for driving an actuating device,
an actuating device that can command the movement of a moveable mechanical member in response to a drive signal delivered by the electronic command system, and
a moveable mechanical member acting on the operating member of the system for selecting and/or adjusting the flow rate of gas, in response to an actuation by the actuating device, such as to block or release the moveable operating member.

Depending on the case, the valve block according to the invention can comprise one or more of the following technical features:
the gas internal passage passes through the valve body.
the gas inlet opening is arranged on an expansion of the valve body which is fixed to the neck of the gas cylinder, preferably a cylindrical or truncated threaded expansion.
the gas outlet opening is borne by an outlet connection.
the movable mechanical member is suitable for and designed to move between at least:
   a first position, called a locking position, in which the mechanical member acts upon the operating member in order to prevent any actuation of said operating member by the user and therefore prevent in this manner any release or passing of gas,
   a second position, called a release position, in which the mechanical member is freed from the operating member such as to allow an actuation of the operating member by the user and a release or a passing of gas.
the electronic command system comprises at least one electronic board.
the electronic command system comprises at least one storage memory integrated in at least one electronic board.
the electronic command system comprises at least one sensor associated with or integrated in at least one electronic board.
the electronic board is designed to be able to interpret one or more measurements coming from the sensor or sensors.
the electronic board comprises an internal clock which blocks the electronic command system at the end of a given shelf life.
the electronic command system comprises several sensors.
it comprises at least one power supply source powering the electronic board, preferably one or more batteries that are optionally rechargeable.
the actuating device is electrically connected to the electronic board.
said at least one sensor is electrically connected to the electronic board.
said at least one sensor is chosen from the sensors for pressure, for flow rate, for temperature, for presence (with contactless detection), for movement (linear or angular), for position (linear or angular), for magnetic field, of inertial type (for example accelerometer, inclinometer, gyroscopes, etc.), for brightness, for end of travel or contact, strain gauges and potentiometers.
the operating member can be rotated or pivoted, and it preferably comprises a rotating wheel or a pivoting lever.
the mechanical member can be translated, pivoted or rotated.
the mechanical member is a shaft, a slug or a pin.
the mechanical member is housed in a housing or against an abutment borne by the rotating wheel or the lever of the system for selecting and/or adjusting the gas flow rate.
it comprises an information memorizing device electrically connected to the electronic command system, preferably a storage memory.
it further comprises a pressure reduction system, for example a pressure reduction system comprising a pressure relief flap and a flap seat. Said pressure reduction system is arranged on the gas internal passage, in particular between the inlet and outlet openings.
it further comprises at least a visual indicating instrument for the locking position and for the release position.

The invention also relates to a gas distribution assembly comprising a gas cylinder provided with a valve block according to the invention.

Depending on the case, the assembly according to the invention can comprise one or more of the following technical features:
the cylinder is a gas bottle.
the gas bottle has a size between 10 and 150 cm.
the gas bottle contains 0.5 to 20 liters (water equivalent capacity).
the gas bottle has a hollow cylindrical body.
the gas bottle comprises a neck bearing an outlet opening for the gas at which the valve block is fixed.
a gas bottle contains a gas or gas mixture chosen from oxygen, air, a N₂O/O₂ mixture, a He/O₂ mixture, a NO/nitrogen mixture or any other gas or gas mixture.
the bottle is made from steel, from an aluminum alloy or from a composite material or a combination of several of these materials.
the bottle contains a gas or gas mixture at a pressure of up to 350 bar approximately.
the valve block is protected by a protective casing arranged about at least part of said valve block.
the valve block is protected by a protective casing comprising a hooking system for suspending or hooking the bottle/casing/valve block assembly to a supporting means, in particular a tubular supporting means, for example a bar of a hospital bed, of a stretcher or the like.

Moreover, the invention relates to a use of an assembly according to the invention in order to store or distribute a gas or a gas mixture. Preferably, a gas or gas mixture is of medical quality. In particular, the gas or gas mixture is chosen from oxygen, air, and the N₂O/O₂, He/O₂ and NO/nitrogen gas mixtures.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates an embodiment of the invention.

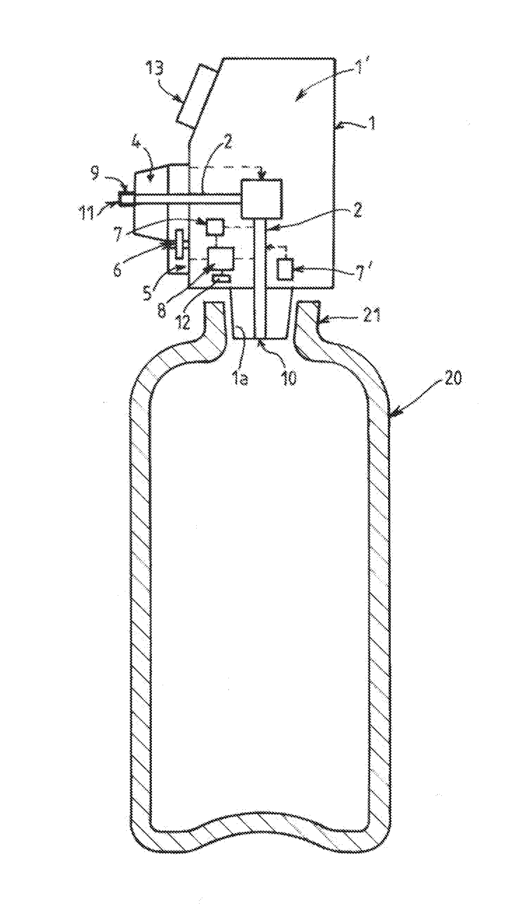

### DESCRIPTION OF PREFERRED EMBODIMENTS

The invention will now be better understood thanks to the following detailed description, given by way of illustration but in a nonlimiting manner, with reference to the appended FIGURE which shows the operating principle of a valve block according to an embodiment of the invention.

More precisely, the FIGURE appended hereto shows a gas distribution assembly according to an embodiment comprising a valve block 1 and a gas cylinder 20, namely in this case a gas bottle containing a pressurized gas, for example a medical gas packaged at a pressure which can reach 300 bar, or more, in particular oxygen, a N₂O/O₂ mixture, a He/O₂ mixture, a NO/N₂ mixture or air. The body 1′ of the valve block 1 is fixed to the neck 21 of the gas bottle 20 by a threaded expansion 1, which is truncated in this case, located at the base thereof, which is inserted and screwed into the neck 21 of the bottle 20.

Conventionally, a gas internal passage 2 provides fluid connection between an inlet opening 10, borne by the truncated threaded expansion 1, and a gas outlet opening 11, borne by an outlet connection 9 to which is fixed a gas pipe, for example a flexible hose, or another apparatus, such as a flowmeter, a pressure regulator, etc. This gas internal passage 2 makes it possible to transport the gas between the bottle 20 and the outlet connection 9.

It is furthermore seen that a gas control system 3 is arranged on the gas internal passage 2, for controlling and/or adjusting the flow rate of gas flowing in the gas internal passage 2. Indeed, according to the chosen embodiment, the gas control system 3 can be designed to allow a release of the gas:
either of the all or nothing type, i.e. open or closed, namely that the gas can be stopped or released without control of the flow rate thereof. In this case, the operating member 4, preferentially a wheel or a lever, acts on a movable element in order to free the gas passage when a gas flow is desired or, conversely, block the gas passage when no gas flow is desired.
or with the possibility of setting the flow rate of gas passing through said gas control system 3 between two flow rate values (i.e. >2) corresponding to several positions of a blocking movable element, including a so-called “0” or “closed” position, in which the gas flow rate is zero and, conversely, a maximum open position, in which the released gas flow rate reaches a desired flow rate maximum value, and several intermediate positions. Again, the flow rate is controlled via the operating member 4, preferentially a wheel or a lever, which will act upon a movable element arranged on the gas passage 2 in order to set the flow rate between the various possible values of flow rate.

The system for selecting and/or adjusting the gas flow rate therefore comprises a movable operating member 4, namely a rotating wheel on the FIGURE appended hereto, which can be actuated by the user and engages the gas control system 3 in order to control and/or adjust the flow rate of gas exiting through the gas outlet opening 11 borne by the outlet connection 9.

The valve block 1 further comprises an electronic command system 7, 7′, 8 for driving an actuating device 5 designed to command the movement of a movable mechanical member 6 in response to a drive signal delivered by the electronic command system 7, 7′, 8.

The electronic command system 7, 7′, 8 comprises an electronic board 8.

In the proposed embodiment, at least one sensor 7, 7′, for example a sensor for pressure 7 or for flow rate and/or a sensor for temperature 7′ or for position, is connected to the electronic board 8 such as to recover the measurement signals coming from said sensor 7, 7′. The actuating device 5 is also electrically connected to the electronic board 8.

Of course, other types of suitable sensors could be used.

A power supply source 12, for example a battery that is optionally rechargeable, a cell or a capacitor, supplies the electronic board 8 with electric current.

The mechanical member 6 that can be translated or rotated, like a shaft, a key or a slug or a pin, acts on the operating member 4, namely in this case the rotating wheel, in response to the actuation thereof by the actuating device 5, such as to block or release the operating member 4.

In the FIGURE, the operating member 4 is a rotating wheel arranged about the outlet connection 9 bearing the gas outlet opening 11 and located on the front face of the valve block 1. However, this embodiment is not exclusive and the outlet connection 9 and/or the operating member 4 could be arranged differently and/or at another location on the valve block 1.

In other words, the mechanical member 6, the movement of which is commanded by the actuating device 5, can move between at least two positions comprising an active position, in which it blocks the operating member 4 and therefore the movable member of the system for opening and/or adjusting the flow rate, thus resulting in the impossibility for the user to free the gas passage towards the gas outlet connection or connections 9, without a specific operation to be undertaken by the user or a maintenance operator.

The valve block 1 can also comprise an information memorizing device electrically connected to the electronic command system 7, 7′, 8, for example a storage memory containing one or more items of useful information, like a date for expiry of the gas or for maintenance of the valve block 1. Such an item of information can also be used by the electronic board 8 in order to command the actuating device 5 and the mechanical member 6 in order to block the operating member 4 and therefore any release of the gas, for example when the expiry date is reached or exceeded.

Generally, the items of information or measurements coming from the sensor(s) 7, 7′ and/or from the storage memory are collected and processed by the electronic board 8 which will automatically command, in response to said items of information or measurements, the actuating device 5 which will act upon the mechanical device 6 in order to block or, conversely, release the operating member 4 of the system for selecting and/or adjusting the gas flow rate and, consequently, depending on the case, allowing or preventing any release of gas by the block 1.

This makes it possible to prevent a use of the gas coming from the bottle 20 when the administration thereof could involve a risk for the patient, for example in the case of an exceeded expiry date or in the case of a N₂O/O₂ mixture being unmixed due to exposing the bottle 20 to an excessively low temperature (<0° C.), since these ‘incidents’ would be detected automatically by the electronic board 8 of the valve block 1 and the board would then immediately command blocking of any rotation of the operating wheel 4 thus preventing any release of the gas.

According to a specific embodiment, the valve block 1 is of the VIPR type, i.e. valve with integrated pressure regulator, i.e. it comprises a system for reducing the pressure of the gas, for example a pressure relief flap and a flap seat system, arranged on the gas internal passage 2, between the inlet 10 and outlet 11 openings, such as to make it possible to reduce the pressure of the gas at high pressure (for example a high pressure of approximately 200 to 300 bar) contained in the bottle 20 to a pressure of use or low pressure (for example a low pressure of approximately one to a few bar).

The valve block 1 can also comprise a pressure indicating device 13, like a pressure gauge, providing the user with a measurement of the pressure of the gas within the bottle 20.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A valve block (1) for a pressurized gas cylinder (20) comprising:
a gas internal passage (2) providing fluid connection between a gas inlet opening (10) and a gas outlet opening (11);
a gas control system (3) arranged on the gas internal passage (2), for controlling and/or adjusting the flow rate of gas flowing in said gas internal passage (2),
a system for selecting and/or adjusting the flow rate of gas comprising a movable operating member (4) which can be actuated by the user and engages the gas control system (3) in order to control and/or adjust the flow rate of gas exiting via the gas outlet opening (11),
an electronic command system (7, 7′, 8) for driving an actuating device (5),
an actuating device (5) that can command the movement of a moveable mechanical member (6) in response to a drive signal delivered by the electronic command system (7, 7′, 8), and
a moveable mechanical member (6) acting on the operating member (4) of the system for selecting and/or adjusting the flow rate of gas, in response to an actuation by the actuating device (5).

2. The valve block of claim 1 wherein the movable mechanical member (6) is suitable for and designed to move between at least:
a first position in which the mechanical member (6) acts upon the operating member in order to prevent any actuation of said operating member (4) by the user, and
a second position in which the mechanical member (6) is freed from the operating member such as to allow an actuation of the operating member by the user and a release of gas.

3. The valve block of claim 1 wherein the electronic command system (7, 7′, 8) comprises at least one electronic board (8).

4. The valve block of claim 1 wherein the valve block comprises at least one power supply source (12) powering the electronic board (8).

5. The valve block as of claim 1 wherein the actuating device (5) is electrically connected to an electronic board (8) of the electronic command system (7, 7′, 8).

6. The valve block of claim 1 wherein the electronic command system (7, 7′, 8) comprises at least one storage memory integrated in at least one electronic board (8).

7. The valve block of claim 1 wherein the electronic command system (7, 7′, 8) comprises at least one sensor (7, 7′) associated with or integrated in at least one electronic board (8).

8. The valve block of claim 1 wherein the operating member (4) that can be actuated by the user can be rotated or pivoted.

9. The valve block of claim 1 wherein the moveable mechanical member (6) can be translated, pivoted or rotated.

10. The valve block of claim 1 wherein the moveable mechanical member (6) is a shaft, a slug or a pin.

11. The valve block of claim 1 wherein the mechanical member (6) is housed in a housing or against an abutment borne by the movable operating member (4), wherein the movable operating member (4) is a rotating wheel or a lever of the system for selecting and/or adjusting the gas flow rate.

12. The valve block of claim 1 wherein the valve block comprises an information memorizing device electrically connected to the electronic command system (7, 7′, 8).

13. The valve block of claim 1 wherein the valve block further comprises a pressure reduction system arranged on the gas internal passage.

14. The valve block of claim 1 wherein the valve block comprises a pressure reduction system comprising a pressure relief flap and a flap seat.

15. A gas distribution assembly comprising a gas cylinder (20) provided with the valve block (1) of claim 1.

16. (canceled)
